(19) United States
(12) Patent Application Publication
(10) Pub. No.: US 2008/0033755 A1
(43) Pub. Date: Feb. 7, 2008

(54) Medical treatment modality for headache, pain, and other medical disorders

(76) Inventor: John Claude Krusz, Dallas, TX (US)

Correspondence Address: WINSTEAD PC, P.O. BOX 50784, DALLAS, TX, 75201, US

(21) Appl. No.: 11/810,618

(22) Filed: Jun. 6, 2007

Related U.S. Application Data
(60) Provisional application No. 60/811,636, filed on Jun. 7, 2006.

(51) Int. Cl. G06Q 50/00

(52) U.S. Cl. 705/2

(57) ABSTRACT

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

### CROSS-REFERENCE TO RELATED APPLICATIONS

This patent application claims priority from, and incorporates by reference the entire disclosure of, U.S. Provisional Patent Application No. 60/811,636, filed January Jun. 7, 2006.

### BACKGROUND OF THE INVENTION

1. Field of the Invention

The present invention relates to a medical treatment modality, and more particularly, but not by way of limitation, to a remote medical treatment modality that is particularly adapted for the treatment of migraine headaches, pain flare ups and other medical issues that are effectively treated with either intramuscular (IM) or intravenous (IV) medical procedures at locations remote from a managing physician. “Remote” as used herein refers to medical treatment modalities where the managing physician is not in physical contact with the patient. “Managing physician” as used herein refers to the physician ultimately responsible for authorizing and/or managing the medical treatment or non-treatment of the patient.

2. History of Related Art

It is well known in the medical community to establish a variety of patient management systems including remote medical offices where examination and treatment can occur. Medical treatment paradigms have been specifically adapted for such remote locations with limitations on procedures that can be performed without direct supervision. For example, video teleconferencing systems and processes have been implemented for medical applications. Prior art approaches disclose a video conferencing system with a host site and a remote site having computer assemblies constructed and arranged to form a computerized video telecommunication system between them. The remote site includes medical apparatus and procedures having visual and/or audio recognition system whereby trained, service, trouble-shooting and instrument installations systems can be conducted from the host site. Likewise, other remote treatment approaches are set forth and shown in a multitude of prior art patents. The following is description of three broad categories of treatment including, the first category of remote treatment, the second category of treatment paradigms and a third category of treatments related to chemical compositions.

Generally, the term “Telemedicine” refers to the delivery of medicine at a distance. The term is composed of the Greek word “Tele” meaning far and “medicine”. Telemedicine generally refers to the use of communications and information technology for the delivery of clinical care. Telemedicine is a term used to describe a type of patient care which involves monitoring of a patient's condition by a healthcare worker located at a healthcare facility which is remote with respect to the location of the patient. Telemedicine, if adequately employed, is capable of providing enormous benefits to society. One such benefit is that patients can be examined without having to travel to a healthcare facility. This feature is particularly important for patients who live in remote areas and may not be able to easily travel to the nearest healthcare facility, or who need to be examined by a healthcare worker located far away from the patient, for example, in another state. Telemedicine may be practiced on the basis of two concepts which may be, for example, synchronous (real-time) and asynchronous (store-and-forward).

Another benefit of telemedicine is that it is capable of allowing a patient to be examined more often than would be possible if the patient were required to travel to a healthcare facility due to the ease with which it can be administered. For example, if a patient's condition requires that measurements be taken several times a day, it would be impractical for the patient to travel to and from a healthcare facility each time a measurement needs to be taken. It probably would be necessary for the patient to be admitted to the healthcare facility. The use of telemedicine could allow these measurements to be taken at the patient's home while the healthcare worker observed the patient or the measurement data from the healthcare facility.

Another benefit of telemedicine is that it allows a patient to be examined in a more timely manner than if the patient was required to travel to the healthcare facility. This is important in urgent situations, such as when a patient's condition becomes critical and emergency procedures must be taken immediately.

Various types of telemedicine systems are known. One example of such a system is disclosed in U.S. Pat. No. 5,441,047 to David et al., issued Aug. 15, 1995, which discloses an ambulatory patient health monitoring system for monitoring a remotely-located healthcare patient from a central station. The system includes instruments at the remote location for measuring the medical condition of the patient. The medical condition may correspond to health parameters, such as heart rate, respiratory rate, pulse oximetry and blood pressure. The system includes a first audiovisual camera disposed at the patient location and a second audio-visual camera disposed at the central station. Audio and video information is transmitted between the patient's remote location and the central station via a communications network, such as an interactive cable television network. Patient data is transmitted between the patient remote location and the central station by a separate communications network, such as satellite, radio transmission or telephone lines. A display is located at the patient's remote location and at the central station to allow the patient and the healthcare worker to observe each other simultaneously.

Another example of a telemedicine system is disclosed in U.S. Pat. No. 5,434,611 to Tamura, issued Jul. 18, 1995. This patent discloses a telemedicine system having a two-way CATV network for transmitting images, voice and data between equipment located at the patient's home and equipment located at a medical office. Cameras are located in both the patient's home and in the medical office to provide return images between the doctor and the patient. In order for the doctor's terminal to communicate with the patient's terminal, the doctor's terminal sends a signal over a control line to the patient's terminal. A line controller then selects a communication channel for the session by selecting an unused channel in a multiple channel access (MCA) system. The terminals then automatically tune to the assigned communications channel and the information is communicated over the assigned channel between the patient and the doctor.

Finally, under the category of treatments related to chemical compositions, U.S. Pat. No. 6,440,983 entitled “Compositions and Methods for Relieving Headache Symptoms in Aspirin-Sensitive Headache Sufferers” discloses administering a combination of acetaminophen, ibuprofen, caffeine, magnesium, and guaifenesin. There are other types of treatments related to chemical compositions addressing the Methods and Compositions for Treatment of Pain and Other Hormone-Allergy-Related Symptoms Using Dilute Hormone Solutions, Methods and Compositions for Treating Headache Pain With Topical NSAID Compositions, Compositions and Methods for Enhancing Analgesic Potency of Tramadol and Attenuating Its Adverse Side Effects, Acute Treatment of Headache With Phenothiazine AntiPsychotics, Method For Providing Long-Lasting Pain Diminishment Through Topical Or Intranasal Administration of Civamide, Migraine Treatments Including Isovalermide Compounds and Serotonin Agonists, and Method and Composition for Treatment of Headache Using Magnesium.

In furtherance of the above, it would be an advantage to provide a method of and system for using IV treatments at remote centers as orchestrated by central medical command and medical authority to permit the remote administration of IM's or IV's for headaches, pain, and other medical and neurological disorders, and particularly for treatment of migraine headaches. The present invention provides such a method and system as set forth herein.

### SUMMARY OF THE INVENTION

The present invention relates to a system and method for medical treatment of select medical issues at a remote medical facility and under remote supervision of a managing physician. In one embodiment, the method comprises providing a central medical facility for the managing physician and providing the remote medical facility for treatment, by at least one skilled medical professional, of at least one patient. A communications network is provided to transmit information between the central medical facility and the remote medical facility wherein the patient at the remote medical facility may be evaluated for treatment of select medical issues by the at least one skilled medical professional. The method further includes monitoring the patient before administering a treatment, generating a medical record of the patient as a result of the monitoring, transmitting, via the communications network, the patient's medical record to the central medical facility for review by the managing physician, reviewing, by the managing physician located at the central medical facility, the patient's medical record, determining, by the managing physician, an appropriate medical treatment for the patient, and authorizing one of an intravenous (IV) or intramuscular (IM) treatment by the managing physician. At this point, the one of an intravenous (IV) or intramuscular (IM) treatment to the patient at the remote medical facility is administered by the at least one skilled medical professional under remote supervision of the managing physician.

In another embodiment, the above method further comprises monitoring the patient during and after the administration of the IM or IV treatment. The monitoring may comprise pulse oximetry monitoring, blood pressure monitoring, and/or applying a monitoring apparatus to the patient, whereby the patient is closely monitored and efficacy of the treatment is determined. The efficacy of the IM or IV treatment is confirmed by the managing physician prior to releasing the patient. The method may also include re-evaluating the patient after administration of the IM or IV treatment to determine if the patient requires continued treatment. As set forth above, the above described method may be used when the select medical issues include headache, migraine, and pain conditions.

In another embodiment, the system for medical treatment of select medical issues comprises a remote medical facility for the treatment of at least one patient by at least one skilled medical professional, a central medical facility for overseeing the treatment of the at least one patient by a managing physician, as described herein, and a communications network adapted to transmit medical records of the at least one patient between the central medical facility and the remote medical facility for authorizing either IM or IV treatment. The central medical facility may include communication means for receiving the medical records of the at least one patient, wherein the communications means includes at least one of a server computer and a mobile communication device and wherein the transmission of medical data occurs in real time.

In another embodiment, the above described system further includes a remote medical facility having, at least one camera/microphone, at least one videoconferencing device, at least one server computer, a patient monitoring system, a mobile communication device, and IM and IV treatment equipment.

The above system further includes, in one embodiment, a managing physician who reviews the medical records of the at least one patient and determines an appropriate medical treatment for the at least one patient, which may include one or both of IV and IM treatment. The IV and/or IM treatment is administered by the at least one skilled medical professional under remote supervision of the managing physician.

In yet another aspect, the above system includes, in one embodiment, a communication network that is one of a community access television (CATV) network, an asynchronous transfer mode (ATM) network, the Internet, a local area network (LAN), and a wide area network (WAN).

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram of a system in accordance with an embodiment of the present invention;

FIG. 2 is a flow diagram in accordance with an embodiment of the present invention; and

FIG. 3 is a block diagram illustrating various components of the system of FIG. 3 in accordance with an embodiment of the present invention.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

The use of Intramuscular IM or intravenous (IV) treatment at remote centers such as relatively small clinics as managed or orchestrated by a centralized medical command, including a managing physician, may facilitate the use of intramuscular (IM) or intravenous (IV) medication strategies for treatment of pain, headache, migraine, muscle spasm, and other emerging and refractory conditions in an outpatient clinic or emergency room environment.

Intractable and ongoing headaches can be treated in many ways by health care practitioners. A patient may be sent to an emergency room to have their headache treated, but this is fraught with multiple kinds of frustrations, and most often, the patient surely does not win. In a specialized setting used by practices that offer intramuscular IM or intravenous (IV) therapy services, intractable headaches and migraine flare-ups can be treated successfully. It requires a nursing staff that is trained in intramuscular (IM) or intravenous (IV) treatment to start and monitor IV lines and IM potential reactions; pulse oximetry monitoring may be desirable in many cases as is noted for some of the medications. A comfortable room or rooms where patients can be treated, and it is hoped that the lights can be dimmed, also is ideal. Many IV rooms are multiuse so that psychologists or the nurse practitioner may also use the rooms.

Teleneurology enables neurology to be practiced when the doctor and patient are not present in the same place, and possibly not at the same time. The two main techniques are: (1) Videoconferencing and (2) Electronic Mail communications (E-mail). Videoconferencing enables communication between a doctor and a patient who are in different places at the same time (often called real-time or synchronous). Electronic Mail communications enables consultation to be carried out without the patient being present and at a time convenient to the doctor involved (asynchronous or store-and-forward teleneurology). Some problems that can be solved by teleneurology include, for example, patients admitted to hospital with acute neurological symptoms rarely see a neurologist, delayed treatment for acute stroke, non-optimum management of epilepsy, unproductive travel time for neurologists, extremely poor access to a neurologist for doctors in the developing world, and long waiting times to see a neurologist. Neurology is a specialty that, because of the emphasis on accurate interpretation of history, does lend itself to telemedicine. Telemedicine requires a significant change in how neurologists practice.

User satisfaction (i.e. that of patients, medical staff at a remote hospital and medical staff at a neurological centre) with real-time teleneurology consultations has been studied prospectively. According to an exemplary study, twenty-five patients with neurological problems admitted to a hospital without permanent neurological cover were assessed from a neurological centre by specialist neurologists using real-time video-links transmitting at, for example, 384 kbit/s. All users reported high levels of satisfaction with the technical aspects of the consultations. Patients, almost universally, reported confidence in teleneurology as a means of dealing with presenting complaints. Similarly, medical staff at either site felt confident in managing patients using teleneurology and felt that a telephone consultation would not have achieved as good an outcome.

According to exemplary embodiments, studies have been conducted to evaluate the use of telemedicine for improving the care of patients admitted with neurological symptoms to hospitals that do not have specialist neurologists on site. According to an exemplary study, comparisons have been performed to the outcome of patients admitted to two small hospitals. In one hospital all patients with neurological symptoms were treated by a neurologist remotely using an interactive video-link transmitting at, for example, 384 kbit/s. In the other hospital, patients with neurological problems were managed as per usual practices. Studies indicated that there was a significant difference for the overall length of hospital episode between the two hospitals. When patients with prolonged hospital episodes were excluded, or only patients with a diagnosis of headache, epilepsy or transient ischemic attack were considered (who as a group made up the bulk of neurological admissions), the difference in the length of hospital episode was not significant. It should therefore be possible to estimate the effect of telemedicine on the management of patients with neurological problems.

In response to new developments and interest in the area of telepsychiatry, literature on this topic has greatly increased over the past three years. A search was conducted on the MEDLINE, PsycINFO, and Telemedicine Information Exchange (TIE) databases for literature published from March 2000 to March 2003 on telepsychiatry applications, using the following terms: telepsychiatry, telepsychology, telemental health, videoconferencing, and video conferencing. Sixty-eight publications were identified over this three-year period, exceeding the 63 publications identified in the previous literature review. The results of findings in six areas are as follows: novel clinical demonstrations and current program descriptions; the reliability of clinical assessments; clinical outcomes; satisfaction of patients and clinicians; cost and cost-effectiveness; and legal, regulatory, and ethical issues. Studies describing existing programs and novel clinical applications support the belief that the use of telepsychiatry is expanding. Overall, studies continued to support the notion that telepsychiatry assessments produced reliable results, telepsychiatric services led to improved clinical status, and patients and clinicians were satisfied with treatment delivered via telepsychiatry. Evidence supported the notion that telepsychiatry is a cost-effective means of delivering mental health services. For the purposes of this patent application, the use of teleneurology techniques is quite akin to that presented for telepsychiatry, as both disciplines are critically dependent on an accurate history from the patient seeking treatment and from the remote provider.

The rapid developments in computers and information technology in the past decade has had an enormous impact on psychology, which has moved in this context from local computer applications to network applications taking advantage of, for example, the Internet. Specifically, ten types of psychological Internet applications are reviewed: information resources on psychological concepts and issues; self-help guides; psychological testing and assessment; help in deciding to undergo therapy; information about specific psychological services; single-session psychological advice through e-mail or e-bulletin boards; ongoing personal counseling and therapy through e-mail; real-time counseling through chat, web telephony, and videoconferencing; synchronous and asynchronous support groups, discussion groups, and group counseling; and psychological and social research.

It appears that teleneurology, particularly where it impacts the treatment of headache and pain conditions, is poised for treatment at medical facilities remote from a managing physician. The broad demographics of headache and pain, each of whom contain approximately 100 million or more patients in the United States, demand more aggressive treatment approaches that cannot be delivered by the few available headache and pain specialists in any given state, due to a shortage of specialists in these areas of medicine. For example, in Texas, there are approximately eleven relatively dedicated headache practices throughout the entire state. Similarly, there are approximately seven or eight neurologists in the whole state of Texas having a dedicated pain practice. For a state the size of Texas and, by extension, other larger states, it makes sense to consider teleneurologic methods of treatment for headache and pain flare-ups either directly or remotely to aid in treatment efforts.

Intravenous Treatment

Intravenous (IV) treatment is the ability to intervene directly with a treatment to reduce or eliminate an ongoing headache or pain flare-up. Most often, this takes the form of an IV infusion of medication in a clinic. Such treatments are much more effective (and much less expensive) than treatment in a hospital-based or emergency room setting.

In order to provide intravenous treatments, one must be set up to do IV treatment to offer this technique of acute intervention. A space is required to perform the service and may be the same examination room where practitioners may examiner patients. According to exemplary embodiments, the space may be, for example, a block room having the capability to perform IV treatments simultaneously. The space may also include a common-use room that may be used by, for example, the psychologists for sessions and feedback, by the physical or massage therapist for treatment, and by the practitioners to see patients with their family members. According to an exemplary embodiment, the practitioner may muster an IV in an easy chair. Some days, practitioners may start their own IVs and the rest of the time it is done by the nurse or the nurse practitioner. The practitioners may routinely use pulse oximetry monitoring because some of the treatments are done more safely with that; also cardiac rhythm disturbances that otherwise might not be known are picked up by using this simple technique.

Multiple types of IV therapies are available, all of which are listed in Table 1.

TABLE 1
Medications for use in the headache clinic

| | | Pulse Oximetry | | |
|---|---|---|---|---|
| Medication | Availability | Monitoring | Cost Factor | IM Use |
| MgSO₄ | Good | Not required | Inexpensive | Yes |
| Antinauseants | Good | Not required | Inexpensive | Yes |
| Steroids | Good | Not required | Inexpensive | Yes |
| DHE45 | Good | Not required | Moderately | Yes |
| | | | expensive | |
| Valproate acid | Good | Not required | Moderate | No |
| Propofol | Good | Required^{a} | Moderate | No |
| Lidocaine | Good | Required^{a} | Inexpensive | Yes |
| Levetiracetam | Special | Required | Expensive | No |
| | compounding | | | |
| Tramadol | Special | Required | Moderate | No |
| | compounding | | | |
| Ketamine | Poor | Required^{a} | Expensive | Yes |
| Methocarbamol | Good | Not Required | Inexpensive | No |

Abbreviations:
IM, intramuscular.
^{a}Advanced cardiac life support trained staff and crash cart is recommended on the premises.

Intravenous MgSO₄

In many ways, this treatment is a sort of “opening shot” for intractable headaches. It can be given alone, or combined with antinauseants (IV metoclopramide, promethazine, prochlorperazine, or droperidol) or with IV steroids. Magnesium has primary effects as a physiologic antagonist to calcium. Magnesium also blocks N-methyl D-aspartate (NMDA)-type glutamate excitatory amino acid activity, and nitric oxide synthesis and release, all of which are factors in migraine pathophysiology or maintenance. Magnesium augments serotonin, which may be a direct means of blocking migraines. Multiple types of headaches, including migraines, migrainous headaches, tension-type headaches, and cluster headaches respond to IV magnesium therapy. For example, 1 to 2 g of IV Mg⁺⁺ given over 30 minutes is well-tolerated and results in 85% reduction of intractable migraine. In addition, Mg⁺⁺ is the gold standard for muscle relaxation; it relieves muscle spasms in the neck area that accompany refractory headache and also works well to relax muscle spasm from any source. In all, this is an easy IV to do or have done for your patient in the emergency room setting.

Intravenous Antinauseants Intravenous Droperidol, Metoclopramide, Promethazine, Prochlorperazine, and Ondansetron

Antinauseants have long been used with acute opiate therapy for headaches and for pain treatment based on the notion that the use of both ages was somehow synergistic. Animal experiments seemed to support this idea, but human studies are not conclusive. Nevertheless, emergency room treatments of headache most often use opiates with antinauseants. There is a growing body of evidence that blockade of central dopamine receptor systems can enhance antinociception or the pain-relieving analgesic properties of opiates.

Intravenous Steroids

There is scant literature on the use of corticosteroids to treat migraines, although there is more data about their use in the treatment of cluster headaches, status migrainosus, or analgesic rebound headaches. Anecdotally, dexamethasone is used for detoxification regimens, and for pain flare-ups. This is not necessarily followed by an oral taper. Most often, dexamethasone is given with IV MgSO₄ because they are compatible in the same IV bag.

Intravenous Dihydroergotamine

Before triptans were available, the gold standard for treating intractable migraines was dihydroergotamine (DHE) which is a compound similar to, but different pharmacologically from, ergotamine. The pharmacologic profile of DHE is predominantly that of a venoconstrictor (as well as an arterial constrictor), whereas ergotamine is a pure arterial vasoconstrictor. Also, ergotamine is fraught with the possibility of rebound migraines and headaches, whereas DHE is not, even with more regular use. DHE can be given IV or IM and has a 10 to 14 half-life. The original IV DHE protocol to treat refractory migraine headaches was introduced in 1986 by it became the mainstay of inpatient and in-clinic treatments. Typically, it is given every 8 hours with metoclopramide, 10 mg IV, for 2 to 3 days. In retrospect, metoclopramide probably also has a migraine blocking effect as discussed under the antinauseants. Intravenous Valproate Sodium

Valproate sodium (divalproex sodium as an enteric-coated preparation) was approved in 1994 for oral use in the United States for the prophylaxis of migraines. It was the first anticonvulsant molecule to be found useful in treating migraines in a prophylaxis manner. An IV version was developed and has been used for the treatment of seizures.

Intravenous Propofol

Interesting results can be stumbled upon serendipitously, as occurred in the case of the preanesthetic agent, propofol. Propofol is routinely used in clinics as a mild sedative before epidural steroid and other nerve blocks in a conscious sedation manner.

Intravenous Lidocaine

Lidocaine is an indiscriminate blocker of Na⁺ channels, and blockade of this system has definite implications for reducing neuropathic pain disorders. Many of the so-called “anticonvulsants” (better termed neuronal stabilizing agents) have this mechanism of action, at least, in their repertoire. All of the same agents also have been shown, at least open-label, to reduce migraines and other headaches.

Intravenous Tramadol

Tramadol has been available in the United States for several years and has been used in Europe for more than 30 years. Approximately, 500 million people worldwide have been treated for pain with this agent, whose pharmacologic activity includes opiate-like effects on the mu receptor, as well as weak presynaptic reuptake inhibition of norepinephrine and serotonin (like venlafaxine or duloxetine).

Intravenous Ketamine

Ketamine is an agent that is active against NMDA-type glutamate receptors that decrease migraine attacks when given subcutaneously. Few compounds block the NMDA family of glutamate receptors. Either they have low potency (eg, dextromethorphan, memantine) or they have high potency and an extremely narrow therapeutic index (eg, ketamine, MK801, phencyclidine). Some headache and pain physicians, tend to think that neuropathic pain, chronic daily headaches, and migraines are extremely similar in their biochemical makeup or under-pinnings in cellular mechanisms. The fields of pain and headache management use common terminologies to describe these convergences: nociceptive pain, peripheral and central sensitization, wind-up, long-term potentiation, and neuroplasticity are concepts that are basic to the expression of these disorders.

Intravenous Methocarbamol

Although methocarbamol is an older muscle relaxant preparation with an uncertain pharmacologic mechanism of action, it is one of the few that is available in an IV form.

Botulinum Toxins

The field of botulinum toxin pharmacology has burgeoned over the last 5 to 8 years in the treatment of pain and headache. Botulinum toxins (type A [BoNTA] and type B [BoNTB]) are approved by the U.S. Food and Drug Administration only for cervical dystonias, including torticollis, strabismus, hemifacial spasm, and blepharospasm. A cosmetic use also is approved. There is no official approval for its use for headaches or pain; therefore, there are no billing codes for treating these clinical conditions with BoNTA or BoNTB. The botulinum toxins, when given IM, act as chemodenervation molecules by attaching to acetylcholine-containing motor nerve fibers and preventing release of the neurotransmitter that is needed to initiate contraction of striated muscle. The effect is long-lived, often months in length.

Given that there are approximately 15 intravenously administered medications currently available for treatment for headache and pain flareups, combinations and permutations of the use of these substances is truly quite large. For the above example, 15 medications offer over 1.3 trillion permutations of possible use in intravenous treatment of headache pain and migraine disorder flareups.

Given that the evaluation of nausea is perhaps the first approach to management of pain and headache flareup symptoms, there are at least seven available agents for the treatment of nausea. Therefore, the treatment of nausea alone would have over 5000 possibilities for treatment.

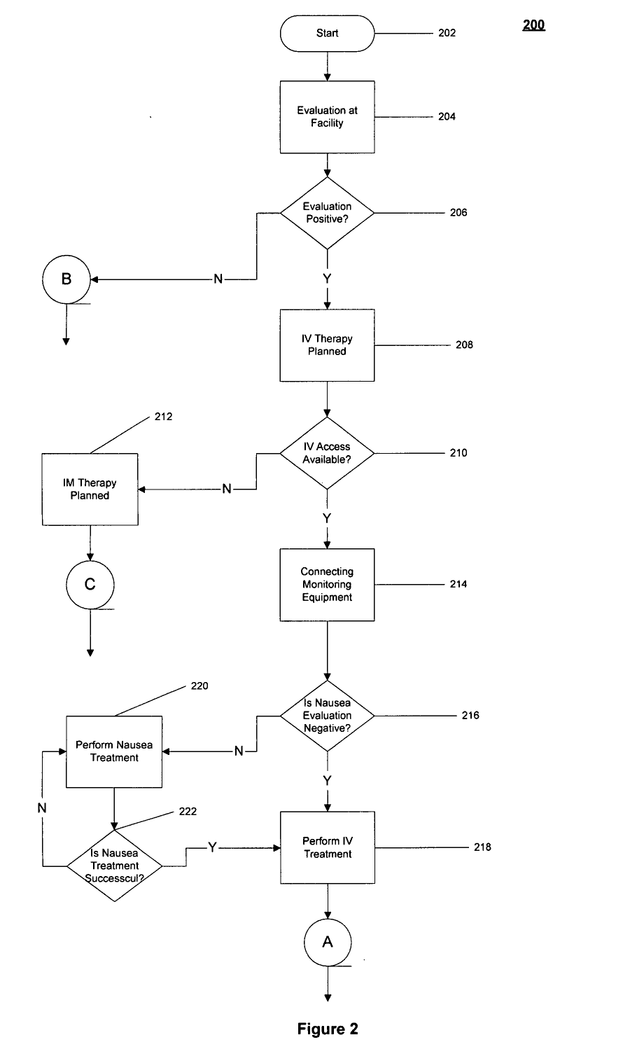

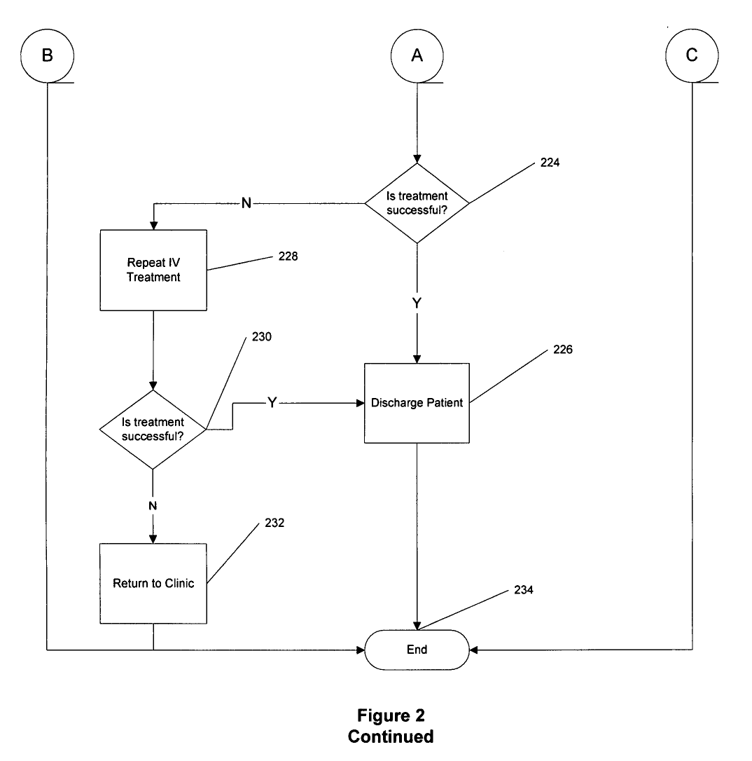

It may thus be seen that aggressive interventional treatment is possible when appropriately managed by an experienced physician. The present invention is the utilization of such aggressive interventional treatment of intractable headaches and other pain issues in remote clinic settings by providing a controlled system that is orchestrated by a managing physician that utilizes conventional telecommunication equipment or telemedicine techniques to both evaluate and authorize IV treatment of patients. This system, as specifically shown in the flow diagram of FIG. 2, permits the ability to formally present an IV treatment strategy both as an instruction manner to other health care providers in the context of seminars, workshops and other educational formats including continuing medical education (CME) as well as the use of telemedicine equipment and technology, Internet medicine technologies, audio visual methods, such as, for example, DVD, CD and tape formats, and related methodologies for implementing the medical paradigm set forth herein. By utilizing such paradigms new agents can be compounded into IV treatments for use in outpatient settings in remote clinics and/or to utilize existing medications in an IV format for the treatment of, for example, headaches, migraines and pain flare-ups.

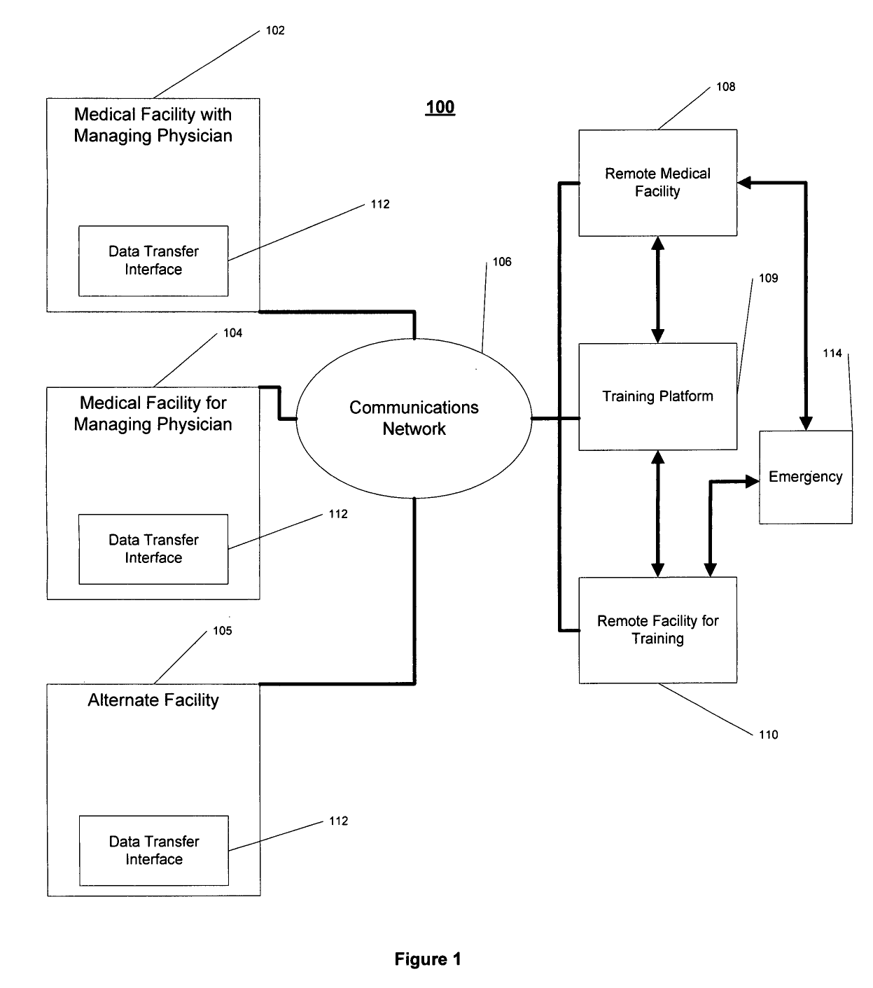

FIG. 1 is a block diagram of a system 100 in accordance with embodiments of the present invention. The system 100 includes a plurality of medical facilities 102, 104 for a managing physician. The plurality of medical facilities 102, 104 are in communication via a communications network 106 to a plurality of remote medical facilities 108 and 110. The remote medical facilities 108, 110 may be, for example, medical facilities, training facilities, and the like. According to embodiment of the present invention, a data transfer interface 112 may be provided at each of the plurality of medical facilities 102, 104 for a managing physician. The data transfer interface 112 is in communication with the communications network 106. According to exemplary embodiments, data is transferred between the plurality of medical facilities 10:2, 104 and the plurality of remote medical facilities 108, 110 in the form of digital data packets. According to exemplary embodiments, the data transfer occurs for example, in real-time or near-real time.

In should be noted that the plurality of medical facilities 102, 104 and the plurality of remote medical facilities 108, 110 may be located at any location capable of having access to the communications network 106. According to exemplary embodiments, the communications network 106 may be multiple types or combinations of network architectures such as, for example, PSTN, ISDN, a cellular or wireless network, a LAN, a WAN, a Community Access Television Network (CATV), the Internet, an ATM network, or a combination of one or more of these networks. According to exemplary embodiments, all of the information transmitted between the plurality of medical facilities 102, 104 and the plurality of remote medical facilities 108, 110 is encapsulated in packets using pre-selected communications protocol. In accordance with an exemplary embodiment, TCP/IP is used as the transport layer/network layer for encapsulating the data in packets. However, other types of communications protocols are suitable for use with the present invention.

According to exemplary embodiments, the system 100 permits the utilization of intramuscular (IM) and intravenous (IV) medication in the plurality of remote medical facilities 108, 110 that are remote from the plurality of medical facilities 102, 104 for the managing physician by utilizing a managing physician skilled in, and knowledgeable of, the utilization of intramuscular (IM) and intravenous (IV) medications for the treatment of select medical issues by utilizing the system 100 providing the necessary communication for monitoring and instructions. In accordance with an embodiment of the present invention, the managing physician is skilled in and knowledgeable of the utilization of not only intramuscular (IM) and intravenous (IV) medications for the treatment of select medical issues such as, for example, migraine headaches, pain flare-ups, but also the procedures associated with remote medical treatment of the patient utilizing intramuscular (IM) and intravenous (IV) medications in locations remote from a managing physician. In that regard, at the plurality of remote medical facilities 108, 110, there are provided both medical equipment for the treatment of a patient with intramuscular (IM) and intravenous (IV) medication as well as monitoring equipment for the patient receiving intramuscular (IM) and intravenous (IV) medication. A communication system 100 is set up for communicating with the remote medical facilities 108, 110 in the event of a serious medical issue and/or reaction occurring from the treatment set forth herein. In that regard, the managing physician in the medical facility 102, 104 is in position to review all procedures and authorize the activation of communication with the plurality of remote medical facilities 108, 110 in the event that the patient so monitored requires such attention.

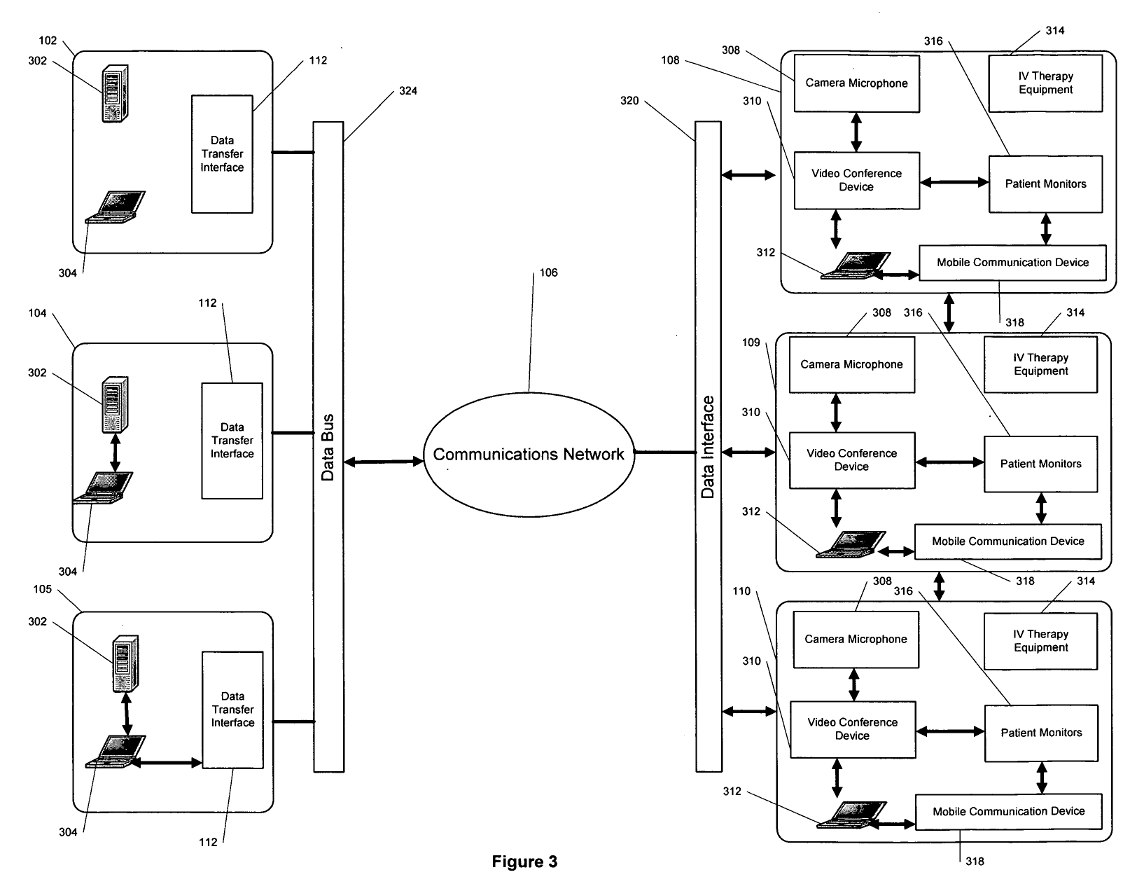

Still referring to FIG. 1, the plurality of medical facilities 102, 104 for the managing physicians may also be located in an alternate orchestration site 105 that is in direct communication via the communications network 106 with the plurality of remote medical facilities 108, 110 or directly through the system 100 itself. For example, the managing physician may be in his or her home office and authorizing the remote medical treatment modality set forth herein due to the managing physician's familiarity with the skilled medical professional trained to perform intramuscular (IM) and intravenous (IV) medical procedures in accordance with the principles of the present invention. The managing physician is thus available to the plurality of remote medical facilities 108, 110 in the event of an emergency, such as when the managing physician is in his home or, in some instances a car. The current state of technology allows a level of telecommunication with for example, computers, mobile communication devices and the like even in a transiting environment. Mobile platforms are in place for facilitating telecommunication that allows a managing physician both audio and video communication with the plurality of remote medical facilities 108, 110. According to exemplary embodiments, a mobile communication device 112 such as, for example, a mobile phone (as shown in FIG. 3) may be available with a display screen allowing the visual observation, by the managing physician, of the plurality of remote medical facilities 108, 110. The managing physician can thus be in a transiting environment utilizing the mobile platform to coordinate and orchestrate the necessary management steps set forth herein, which is particularly helpful in an emergency situation.

Still referring to FIG. 1, a training platform 109 is likewise provided to each of the plurality of remote medical facilities 108, 110 and the managing physician who may also be at alternate orchestration site 105 so that the managing physician understands to a high level of specificity the level of training and requisite abilities provided to the plurality of remote medical facilities 108, 110. Each of the individuals present in the plurality of remote medical facilities 108, 110 are tied in to the system 100 and receive the training from the training platform 109. Likewise, the individuals at an emergency medical facility 114 are likewise trained so as to understand all the related issues that may occur from the remote medical treatment modality set forth and shown herein.

According to an alternate embodiment of the present invention, the system 100 permits the ability to formally present an intramuscular (IM) and intravenous (IV) treatment strategy both as an instruction manner to other health care providers in the context of seminars, workshops and other educational formats including continuing medical education (CME) as well as the use of telemedicine equipment and technology, Internet medicine technologies, audio visual methods, such as, for example, DVD, CD and tape formats, and related methodologies for implementing the medical paradigm set forth herein. By utilizing such paradigms new agents can be compounded into intramuscular (IM) and intravenous (IV) treatments for use in outpatient settings in remote clinics and/or to utilize existing medications in an IV or IM format for the treatment of, for example, headaches, migraines and pain flare-ups.

FIG. 2 illustrates a flow diagram in accordance with an embodiment of the present invention. FIG. 2 illustrates one embodiment of how a typical IV treatment protocol works in flare-ups of migraines or painful disorders that are most appropriately treated by the aggressive interventional treatment set forth and described above. Although IM may be used, IV is sometimes the preferred choice of the managing physician.

Still referring to FIG. 2, the flow diagram therein shown illustrates preparations for a remote medical treatment leading up to a first evaluation of a patient by a remote medical facility 108, 110. The term remote medicalfacility as used herein is any medical facility that is physically remote from a managing physician skilled in and knowledgeable of the utilization of intravenous medications for the treatment of select medical issues. From the evaluation by a skilled medical professional trained to perform intravenous medical procedures in conjunction with a managing physician, a patient is considered to be appropriate for treatment in accordance with the methods and systems of the present invention or directed to visit a medical treatment facility which is itself capable of intravenous medical procedures. As referenced herein, the flow diagram 200 thus shows the aforesaid evaluation steps with the evaluation as step 204. For example, the evaluation is performed by a skilled medical professional in a face-to-face visit at the remote medical facility 108, 110 having the capability for intravenous medical treatment.

After the evaluation step 204, the process 200 proceeds to step 206. At step 206, it is determined if the evaluation is positive. If it is determined at step 206 that the evaluation is positive, the process 200 proceeds to step 208 where IV treatment is planned. However, if it is determined at step 206 that the evaluation is negative, the process ends at step 234.

From step 208, the process 200 proceeds to step 210. At step 210, it is determined if IV access is available. If it is determined at step 210 that IV access is unavailable, the process 200 proceeds to step 212 where intramuscular (IM) injection therapies are instructed. According to exemplary embodiments, intramuscular injection therapies may be the result of the lack of availability of some element of the procedures or equipment in accordance with the principles of the present invention which results in the determination that IM therapy is more appropriate. From step 212, the process 200 ends at step 234.

However, if it is determined at step 210 that IV access is available, the process 200 proceeds to step 214. At step 214, patient monitoring system 316 (FIG. 3) is connected to the patient, which monitoring system 316 can be reviewed by a managing physician at a medical facility 102, 104, 105 distant from the remote medical facility 108, 110. According to exemplary embodiments, in order to facilitate such review by managing physician, the remote medical facility 108, 110 is provided with not only intravenous medical equipment for the treatment of a patient with intravenous medication but also monitoring equipment for the patient receiving intravenous medication and at least one system between the remote medical facility 108, 110 and the medical facility 102, 104 of the managing physician for the orchestration of the intravenous medical procedures. Once the monitoring equipment at step 214 is in place in conjunction with the telecommunication equipment herein described, an evaluation of nausea is performed at step 216.

If it is determined at step 216 that the result of the nausea evaluation is negative, the process proceeds to step 218. At step 218, an IV treatment paradigm is performed. However, if it is determined at step 216 that the nausea evaluation is positive, the process 200 proceeds to step 220. At step 220, a nausea treatment paradigm is performed. At step 222, it is determined if the nausea treatment is successful. If it is determined at step 222 that the nausea treatment is not successful, the process 200 proceeds returns to step 220. However, if it is determined at step 222 that the nausea treatment is successful, the process 200 proceeds to step 218 where IV treatment paradigm is performed. From step 218, the process proceeds to step 224.

At step 224, it is determined if the IV treatment performed at step 218 is successful. If it is determined at step 224 that the IV treatment is successful, the patient is discharged at step 226 and the process ends at step 234. However, if it is determined at step 224 that the IV treatment is unsuccessful, the process proceeds to step 228 where IV treatment is repeated. From step 228, the process 200 proceeds to step 230. At step 230, it is determined if the re-treatment procedure is successful. If it is determined at step 230 that the re-treatment procedure is not successful, the process 200 proceeds to step 232 where the patient is instructed to return to a clinic for further treatment(s). However, it is determined at step 230 that the re-treatment procedure is successful, the process returns to step 226 where the patient is discharged. Still referring to FIG. 2, the re-treatment step 228 is determined in coordination with the managing physician through the system 100 as described in FIG. 1.

Referring now to FIG. 3, there is shown a block diagram of an implementation of the system 100 illustrated in FIG. 1. FIG. 3 demonstrates one of a medical facility 102, 104, 105 for a managing physician and one of a remote medical facility 108, 110. Each medical facility 102, 104, 105 comprises a cellular communication device 302, a server computer 304 and a data transfer interface 112. According to exemplary embodiments, the server computer 304 may be, for example, a personal computer or the like. According to exemplary embodiments, the server computer 304 is connected to the communications network 106 for communication with multiple other server computers. The server computer 302 represents one of a plurality of server computers that may be communicated through the communications network 106 and operated by the managing physician at the medical facility 102, 104 or by the managing physician at the alternate orchestration site 105. Likewise multiple computers may be used by the managing physician and the depiction of the single computer is not meant to limit in any way the spirit and scope of the present invention.

In accordance with an embodiment of the present invention, the data transfer interface 112 comprises ports to communicate with the mobile communication device 302 and the server computer 304. Each medical facility 102, 104, 105 is interoperably connected to the communications network 106 via address/data bus 324. According to exemplary embodiments, the communications network 106 may be multiple types or combinations of network architectures such as, for example, PSTN, ISDN, a cellular or wireless network, a LAN, a WAN, a Community Access Television Network (CATV), the Internet, an ATM network, or a combination of one or more of these networks. According to exemplary embodiments, all of the information transmitted between the plurality of medical facilities 102, 104 and the plurality of remote medical facilities 108, 110 is encapsulated in packets using pre-selected communications protocol. In accordance with an exemplary embodiment, TCP/IP is used as the transport layer/network layer for encapsulating the data in packets. However, other types of communications protocols are suitable for use with the present invention. In accordance with an embodiment of the present invention, the information may be transmitted between the plurality of medical facilities 102, 104 and the plurality of remote medical facilities 108, 110 via electronic mail messages, audio messages, videoconferencing, and the like.

Still referring to FIG. 3, the remote medical facility 108, 110 comprises a camera/microphone 308, a videoconferencing device 310, a server computer 312, an IV therapy equipment 314, a patient monitoring system 316, and a cellular communication device 518. The remote medical facilities 108, 110 and the training platform 109 are connected to the communications network 106 via data interface 320.

According to exemplary embodiments, the videoconference device 310 comprises hardware and/or software which allows for the transmission of video data over the communications network 106. The camera/microphone 308 is adapted to monitor individuals and activities. The camera/microphone 308, the videoconferencing device 310, the server computer 312 as well as the patient monitoring system 316 are all interconnected. In this way the camera/microphone 308 and the video conferencing device 310 can provide direct communication between the remote medical facility 108, 110 and the managing physician in medical facility 102, 104 or alternate orchestration site 105.

In operation, the systems of FIGS. 1 and 3 are utilized in conjunction with the flow diagram of FIG. 2 to permit remote medical treatment of a patient utilizing intravenous medication in locations remote from a managing physician by providing the managing physician with sufficient training to be skilled in and knowledgeable of the utilization of intravenous medications for the treatment of select medical issues and the supervision thereof. The remote medical facility 108, 110 is provided with medical equipment for the treatment of the patient with intravenous medication. The remote medical facility 108, 110 is provided with both a skilled medical professional trained to perform intravenous medical procedures in accordance with the training platform 109 described above and with the various equipment as described above for a patient receiving intravenous medication. Although IM injections may be authorized by the managing physician, the issue of IV treatment will be primarily discussed in the following paragraphs.

According to exemplary embodiments, the patient is evaluated at the remote medical facility 108, 110 by a skilled medical professional. According to an exemplary embodiment, a skilled medical professional may be, for example, an individual trained to perform the intravenous medical procedures and communicate with the managing physician. Decisions are made relative to the application of the intravenous medical procedures. Upon the acceptance of the treatment as the appropriate modality, patient monitoring equipment 316 are applied to the patient, if not already applied for the initial evaluation, and the patient is monitored. The patient may be monitored both during and after the application of intravenous medication. The patient is, of course, monitored during the application of intravenous medication.

Once the intravenous therapy has been authorized by the managing physician through the healthcare provider at the remote facility, the intravenous therapy is applied. It is at this point that the condition of the patient is carefully monitored and decisions are made by the managing physician as well as the skilled medical professional at the remote medical facility 108, 110. It is therefore in accordance with the principles of the present invention that the efficacy of the procedure is used in the intravenous therapy are confirmed by the managing physician and as well as the condition of the patient. In this manner, the necessary steps are authorized relative to the patient for the continued treatment and/or release of the patient receiving the intravenous therapy.

Finally, the treatment paradigm of the present invention permits the bringing together of diverse medications to use in treating flare-ups of headaches and pain in an outpatient environment. Such environment may include an emergency room or remote clinic facility where such IV management is not immediately available and may be utilized in conjunction with the teachings of the present invention. The medical treatment facilities described herein are typically those not ordinarily adapted for such sophisticated medical operations and applications. The present system would allow such remote centers to have the benefit of such advanced treatment paradigms allowing control over training, procedural activities, evaluation processes and the like without the need for the patient with pain and headache to come to the central facility.

In accordance with the principles of the present invention, appropriately licensed skilled medical professional would have in place appropriate patient monitoring equipment 316 allowing the managing physician to orchestrate all procedures. For example, blood pressure readings, heart rate reading, oxygen saturation reading and the like could be communicated to the managing physician. This would be in conjunction with the IV treatment therein orchestrated in this manner, drugs such as lidocaine and others described above could be utilized for the aggressive interventional treatment of intractable headaches in a remote clinic setting. Because adverse reactions may occur with IV applications, the managing physician would confirm that appropriate training is in place for the remote clinic practitioners to allow the appropriate care of the patient receiving the IV solution. For example, a nurse would be appropriately trained in CPR and have available to her a “crash cart” which is updated with the appropriate medications and other equipment to adequately render aide to a patient having an adverse reaction to the IV solution. The training would also include a level of understanding of when to call for emergency help.

In accordance with the principles of the present invention, the present invention discloses the treatment aspects rather than the process of using which medication to use first and which medication to use after. The idea is for treatments across the street, across the state, across the country, or across the world. Studies indicate success rates between 96%-97% using the IV techniques disclosed in the method and system of the present invention. In the context of the present application, success refers to a better than 50% reduction in the pain or headache symptom that the patient to the clinic with. This is far in excess of success rates in ordinary venues like the emergency room, where treatment of headache and pain is often a time consuming and inefficient process.

An advantageous embodiment of the present invention is the time-efficiency of successful treatments for headache and pain flare-ups. Utilizing the method and system of the present invention, it would take a fraction of the time that would be consumed in the typical emergency room setting. Knowing what questions to draw out from the patient and the referring remote practitioner speeds the process of successful treatment strategies.

Another advantageous embodiment of the present invention includes the creation of teaching conferences so that specialists/physicians could, in effect, train other practitioners via continuing medical education seminars and meetings to act as teachers for their colleagues who desire to be more effective at treatment choices. Training could also include education of mid-level health-care providers such as physician assistants and nurse practitioners, in addition to virtually any kind of physician.

It should be emphasized that the terms “comprise”, “comprises”, and “comprising”, when used herein, are taken to specify the presence of stated features integers, steps, or components, but do not preclude the presence or addition of one or more other features, integers, steps, components or groups thereof.

The following are five clinical scenarios that would exemplify the methodology described herein. Any of the following scenarios can be performed either with direct treatment, or treatment by the remote means set forth above. Relative to this description, the following are potential medications that might be utilized in treatment scenarios of the type herein described.

Magnesium sulfate—used in both headache and pain treatment and has muscle relaxant and pain reducing properties.

Dexamethasone—a steroid used to treat inflammation that is part of headache and pain flareups.

DHE 45—a migraine specific treatment given intravenously.

Depacon (valproate sodium)—a migraine-specific agent that has anticonvulsant activity as well.

Antinauseants: comprising a number of substances that are either related or unrelated chemically and mechanistically, including:

Promethazine, prochlorperazine, metochlopramide, droperidol, ondansetron, granisetron. The first two have one mechanism of action, the second two another, and the last two a completely different mechanism of action.

Propofol—an anesthetic agent use in conscious sedation doses for intractable migraines and pain.

Tramadol—an intravenous version of an oral pain medication and has utility for pain and headache flare ups.

Lorazepam—a benzodiazepine which is used to quiet agitation

Levetiracetam—an anticonvulsant that has properties to reduce cluster headaches, trigeminal neuralgia, migraines, and flareups of pain.

Ketamine—an anesthetic agent and blocks NMDA glutamate receptors.

Ketorolac—a nonsteroidal anti-inflammatory for pain and headache flareups.

Ziprasidone—an atypical antipsychotic/dopamine blocking agent with utility for mania, agitation, headache, and pain.

Nalbuphine—an opioids, used for pain and headaches.

Six clinical scenarios will now be presented for purposes of exemplary purposes only:

Scenario One

Refractory Headache/Migraine without Nausea

The patient would come to the facility and either be treated directly, under supervision, or if the treating facility is at a distance from the treatment director, the above described equipment would be in place and operating prior to any treatment. As a first treatment, magnesium sulfate, 1 to 3 g, would be infused over approximately one hour. The patient would rate of headache severity on a 0 to 10 scale every 10-15 minutes during the infusion. Depending on the efficacy of the first agent, ketorolac or dexamethasone dish can be infused over the next forty five minutes to one hour. After that, either DHE 45 or Depacon (valproate sodium) or tramadol may be tried, one at a time. As a last resort, ketamine or propofol could be given.

Scenario Two

Refractory Headache/Migraine with Prominent Nausea

The first focus would be on getting control of the nausea and vomiting. If moderately severe, any of the antinauseants listed above would be useful. However, if the nausea is quite severe and protracted, ondansetron and droperidol would be particularly useful either alone or together. After there is controlled nausea, the items listed in scenario one could be utilized in any order, focuses agents if they headache is quite severe. If the headache is accompanied by agitation then Depacon or lorazepam would be particularly useful.

Scenario Three

Refractory Pain without Headache

In this scenario, propofol or ketamine may be primary agents to be followed by steroids and magnesium. No particular order is given in the severity of the pain in the length of the symptoms direct which treatment approach will be chosen at the outset. If muscle spasm is prominent as well as pain, magnesium sulfate may be the agent that is running throughout the entire treatment, while other treatments are presented one at a time.

Scenario Four

Refractory Pain and Headache

Here, the severity of the length of symptoms and the amount of disability will dictate which agents are picked first. If headache is more prominent, DHE 45 with metochlopramide, Depacon All-Pro will fall might be used as first agents. Infusions maybe lengthier than usual, if the symptoms are particularly severe.

Scenario Five

Refractory Headache and Pain with Nausea and Vomiting

In this scenario, the nausea and vomiting may very well be the first point of attack and since many of them same IV medications can help either migraines or pain flareups, the entire protocol will be dictated by the severity of the presentation, the length of symptoms and the amount of disability.

Scenario Six

Acute Agitation/Mania/Anxiety/Panic Disorder

Here, the protocol may be quite simple and ziprasidone wore lorazepam may be the most useful initial first treating agent(s). additionally, propofol may also be quite useful to achieve conscious sedation and break the acute cycle of panic disorder.

Obviously, preferences will vary and the teaching of others to utilize one or another medication as a primary agent for treatment will also vary.

The previous detailed Description is of embodiment(s) of the invention. The scope of the invention is instead defined by the following claims and the equivalents thereof.

What is claimed is:

1. A method for medical treatment of select medical issues at a remote medical facility and under remote supervision of a managing physician, the method comprising:
providing a central medical facility for the managing physician;
providing the remote medical facility for treatment, by at least one skilled medical professional, of at least one patient;
providing a communications network adapted to transmit information between the central medical facility and the remote medical facility;
evaluating the patient at the remote medical facility for treatment of select medical issues by the at least one skilled medical professional;
monitoring the patient before administering a treatment;
generating a medical record of the patient as a result of the monitoring;
transmitting, via the communications network, the patient's medical record to the central medical facility for review by the managing physician;
reviewing, by the managing physician located at the central medical facility, the patient's medical record;
determining, by the managing physician, an appropriate medical treatment for the patient;
authorizing one of an intramuscular (IM) or intravenous (IV) treatment by the managing physician; and
administering one of an intramuscular (IM) or intravenous (IV) treatment to the patient at the remote medical facility by the at least one skilled medical professional under remote supervision of the managing physician.

2. The method of claim 1, further comprising monitoring the patient during and after the administration of the intravenous (IV) treatment.

3. The method of claim 1, wherein the monitoring comprises pulse oximetry monitoring.

4. The method of claim 1, wherein the monitoring comprises blood pressure monitoring.

5. The method of claim 1, wherein the administering comprises applying a monitoring apparatus to the patient, whereby the patient is closely monitored and efficacy of the treatment is determined.

6. The method of claim 1, further comprising confirming an efficacy of the intravenous (IV) treatment by the managing physician prior to releasing the patient.

7. The method of claim 1, further comprising re-evaluating the patient after administration of the intravenous (IV) treatment to determine if the patient requires continued treatment.

8. The method of claim 1, wherein the select medical issues include headache, migraine, and pain conditions.

9. The method of claim 1, wherein the at least one skilled medical professional includes an individual trained in administering intravenous (IV) treatments.

10. The method of claim 1, wherein the communications network is a community access television (CATV) network.

11. The method of claim 1, wherein the communications network is an asynchronous transfer mode (ATM) network.

12. The method of claim 1, wherein the communications network is the Internet.

13. The method of claim 1, wherein the communications network is a local area network (LAN).

14. The method of claim 1, wherein the communications network is a wide area network (WAN).

15. The method of claim 1, wherein the transmitting occurs in real time.

16. A system for medical treatment of select headache, pain and other medical and neurological issues comprising:
a remote medical facility for the treatment of at least one patient by at least one skilled medical professional trained for both intramuscular (IM) and intravenous (IV) treatments of a patient;
a central medical facility for monitoring the treatment of the at least one patient by a managing physician adapted for managing medical treatment of a patient at a remote location;
a communications network adapted to transmit monitoring information and medical data of the at least one patient between the central medical facility and the remote medical facility; and
a supply of intramuscular (IM) and intravenous (IV) drugs disposed at the remote medical facility and adapted for treatment of one of headache, pain, and other neurological disorders.

17. The system according to claim 16, wherein the central medical facility includes a communication network for receiving the monitoring information and medical data of multiple patients at multiple remote medical facilities.

18. The system of according to 17, wherein the communications network includes at least one of a server computer and a mobile communication device.

19. The system of according to 16, wherein the transmission of monitoring information and medical data occurs in real time.

20. The system of according to 16, wherein the a remote medical facility comprises:
at least one camera/microphone;
at least one videoconferencing device;
at least one server computer;
a patient monitoring system;
a mobile communication device; and
intravenous (IV) and intramuscular (IM) treatment equipment.

21. The system according to claim 16, wherein the managing physician reviews the medical data of the at least one patient and determines an appropriate medical treatment for the at least one patient.

22. The system according to claim 21, wherein the appropriate medical treatment includes one of an intravenous (IV) treatment and an intramuscular (IM) treatment.

23. The system of according to claim 22, wherein the intramuscular (IM) or intravenous (IV) treatment is administered by the at least one skilled medical professional under remote supervision of the managing physician.

24. The system of claim 16, wherein the remote medical facility includes medical equipment to evaluate the at least one patient by the skilled medical professional to determine if one or both of intramuscular (IM) and intravenous (IV) treatment of select medical issues is required.

25. The system of claim 16, wherein the select medical issues include migraine headache conditions.

26. The system of claim 16, wherein the remote medical facility is adapted to monitor the at least one patient.

27. The system of claim 16, wherein the communications network is adapted for transmitting medical records of the at least one patient between the remote medical facility and the central medical facility via an electronic mail message.

28. The system of claim 16, wherein the communications network is adapted for transmitting medical records of the at least one patient between the remote medical facility and the central medical facility via a mobile communication device.

29. A system for medical treatment of selected medical issues at remote medical facilities under remote supervision of a managing physician, the system comprising:
a central medical facility for the managing physician;
a remote medical facility having at least one skilled medical professional skilled for treating at least one patient;
communications network adapted to transmit information between the central medical facility and the remote medical facility;
equipment for evaluating the patient at the remote medical facility for treatment of select medical issues by the at least one skilled medical professional;
equipment for monitoring the patient before administering a treatment;
equipment for medical record generation of data pertaining to the patient as a result of the monitoring;
means for transmitting, via the communications network, the patient's medical record to the central medical facility for review by the managing physician;
means for reviewing, by the managing physician located at the central medical facility, the patient's medical record for determining, by the managing physician, an appropriate medical treatment for the patient;
a supply of intramuscular (IM) and intravenous (IV) drugs for authorization of treatment by the managing physician; and
means for administering one of an intramuscular (IM) or intravenous (IV) treatment to the patient at the remote medical facility by the at least one skilled medical professional under remote supervision of the managing physician.

30. The system of claim 29, wherein the communications network is a community access television (CATV) network.

31. The system of claim 29, wherein the communications network is an asynchronous transfer mode (ATM) network.

32. The system of claim 29, wherein the communications network is the Internet.

33. The system of claim 29, wherein the communications network is a local area network (LAN).

34. The system of claim 29, wherein the communications network is a wide area network (WAN).

35. The system of claim 29, wherein the means of transmitting is adapted for real time transmission.
